(19) United States
(12) Patent Application Publication
(10) Pub. No.: US 2021/0095678 A1
(43) Pub. Date: Apr. 1, 2021

(54) ELECTRIC AIR PUMP FOR INFLATABLE PRODUCT

(71) Applicant: DONGGUAN HONGSHENG METAL & PLASTIC TECHNOLOGY CO., LTD., Dongguan City (CN)

(72) Inventor: Chunhua Yang, Dongguan City (CN)

(21) Appl. No.: 16/589,052

(22) Filed: Sep. 30, 2019

(51) Int. Cl. F04D 25/06; F16K 15/02

(52) U.S. Cl. CPC F04D 25/06; F16K 15/028

(57) ABSTRACT

An electric air pump for an inflatable product includes an air pump, a hand wheel switch, an air switching cylinder, a diverter, a check valve and an air pump assembly. A second vent of the hand wheel switch selectively communicates with the diverter through the air switching cylinder. The air pump assembly has a pump chamber, an air inlet and an air outlet. An air switching hole of the diverter can selectively communicate with the first accommodating chamber. By switching different airflow passages, the inflation and deflation efficiency can be improved, and the service life of the motor can be prolonged.

### BACKGROUND OF THE INVENTION

### 1. Field of the Invention

The present invention relates to an air pump, and more particularly to an electric air pump for an inflatable product.

### 2. Description of the Prior Art

A conventional electric air pump generally adopts a single passage for inflation and deflation, that is, the inflation and deflation uses the same airflow passage, which easily causes the airflow collision in the inflation and deflation process, affects the inflation and deflation efficiency, and is inconvenient to use. Besides, the conventional electric air pump generally uses a motor to speed up the flow of air. As the use time increases, the motor generates a large amount of heat. If the heat is not timely dissipated, the motor may burn out to affect the service life of the air pump.

### SUMMARY OF THE INVENTION

In view of the drawbacks of the prior art, the primary object of the present invention is to provide an electric air pump for an inflatable product. On the one hand, it can switch different airflow passages in an inflation state and in a deflation state to improve the inflation and deflation efficiency. On the other hand, it can effectively improve the heat dissipation effect of the motor and prolong the service life of the motor. Besides, because the hot gas has a certain pressure, the inflation efficiency can be accelerated to a certain extent, and it is more convenient to use.

In order to achieve the above objects, the present invention adopts the following technical solutions:

An electric air pump for an inflatable product comprises an air pump base having a first accommodating chamber and a first vent. A hand wheel switch, an air switching cylinder, a diverter, a check valve and an air pump assembly are installed in the first accommodating chamber of the air pump base.

The hand wheel switch is disposed in a hand wheel switch mounting hole and extends out of the air pump seat. The hand wheel switch is coupled with the air switching cylinder. The hand wheel switch is provided with a second vent for communicating with outside air. The second vent is selectively in communication with the diverter through the air switching cylinder.

The air pump assembly includes a housing, a motor and blades. The motor and the blades are mounted in the housing. The housing has a pump chamber, an air outlet and an air inlet communicating with the first accommodating chamber. The pump chamber communicates with the air outlet and the air inlet.

The diverter is connected to the air pump assembly. The diverter has a diverter inner chamber. The diverter further has a first hole, a second hole, an air switching cylinder mounting hole, a transition hole and an air switching hole that are in communication with the diverter inner chamber, respectively. An end surface of the first hole of the diverter is sealedly connected to an inner wall surface of the first vent of the first accommodating chamber. The first hole communicates with the first vent. The transition hole communicates with the air switching cylinder mounting hole. The pump chamber is in communication with the diverter inner chamber through the air outlet and the transition hole. The air switching hole selectively communicates with the first accommodating chamber.

The check valve is configured to open or close the first vent. The air switching cylinder is installed in the air switching cylinder mounting hole so that an outer circumference of the air switching cylinder when rotated can conduct or block communication between the first vent and the pump chamber.

The check valve includes an air sealing plate, a first valve bracket, and an elastic member. The air sealing plate is connected to the first valve bracket. The first valve bracket is provided with a first engaging protrusion. The first engaging protrusion is located in the second hole and extends out of the diverter. The outer circumference of the air switching cylinder is formed with an annular side. One end of the elastic member is fixed to an inner wall of the diverter inner chamber, and another end of the elastic member is connected to the first valve bracket.

Compared with the prior art, this invention has obvious advantages and beneficial effects. Specifically, the invention mainly adopts the cooperation of the air switching cylinder, the diverter and the check valve. On the one hand, it can switch different airflow passages in an inflation state and in a deflation state to improve the inflation and deflation efficiency. On the other hand, the airflow is inflated or deflated through the pump chamber, which can effectively improve the heat dissipation effect of the motor and prolong the service life of the motor. Besides, because the hot gas has a certain pressure, the inflation efficiency can be accelerated to a certain extent, and it is more convenient to use.

Secondly, through the cooperation of the micro switch and the second engaging protrusion, the micro switch and the check valve are controlled while the hand wheel switch is rotated, and the motor can be energized only by the rotation of the hand wheel switch. It is easy to operate, good in practicality, simple in structure, easy to produce and assemble.

Furthermore, the airtightness between the diverter and the inner wall of the first accommodating chamber is improved by the design of the second valve bracket and the air sealing plate to ensure the feasibility in the working state.

The overall structural design is clever and reasonable, and the assembly between the parts is convenient and firm, ensuring the stability and reliability of the product in operation.

### BRIEF DESCRIPTION OF THE DRAWINGS

FIG. 1 is a perspective view according to a first embodiment of the present invention;

FIG. 2 is a first exploded view according to the first embodiment of the present invention;

FIG. 3 is a second exploded view according to the first embodiment of the present invention;

FIG. 4 is a top view according to the first embodiment of the present invention in a stop state, without the lid;

FIG. 5 is an exploded view of the check valve according to the first embodiment of the present invention;

FIG. 6 is an exploded view of the diverter according to the first embodiment of the present invention;

FIG. 7 is a schematic view according to the first embodiment of the present invention in an inflation state;

FIG. 8 is a schematic view according to the first embodiment of the present invention in a stop state;

FIG. 9 is a schematic view according to the first embodiment of the present invention in a deflation state;

FIG. 10 is a perspective view according to a second embodiment of the present invention;

FIG. 11 is an exploded view according to the second embodiment of the present invention;

FIG. 12 is a perspective view of the air switching cylinder according to the second embodiment of the present invention;

FIG. 13 is an exploded view of the diverter according to the second embodiment of the present invention;

FIG. 14 is a schematic view according to the second embodiment of the present invention in an inflation state;

FIG. 15 is a schematic view according to the second embodiment of the present invention in a stop state; and

FIG. 16 is a schematic view according to the second embodiment of the present invention in a deflation state.

### DETAILED DESCRIPTION OF THE PREFERRED EMBODIMENTS

Embodiments of the present invention will now be described, by way of example only, with reference to the accompanying drawings.

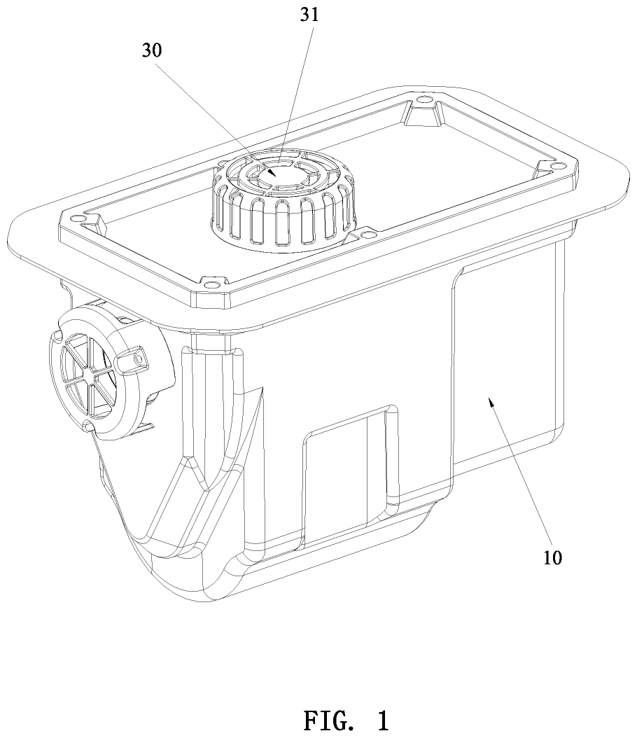

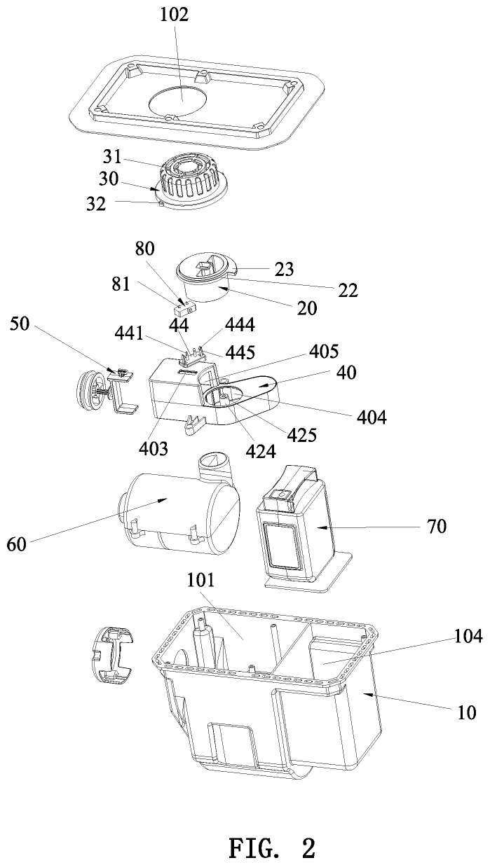

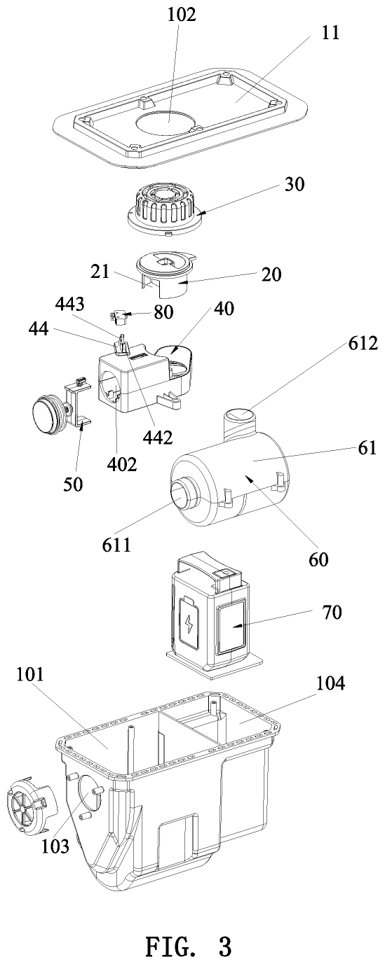

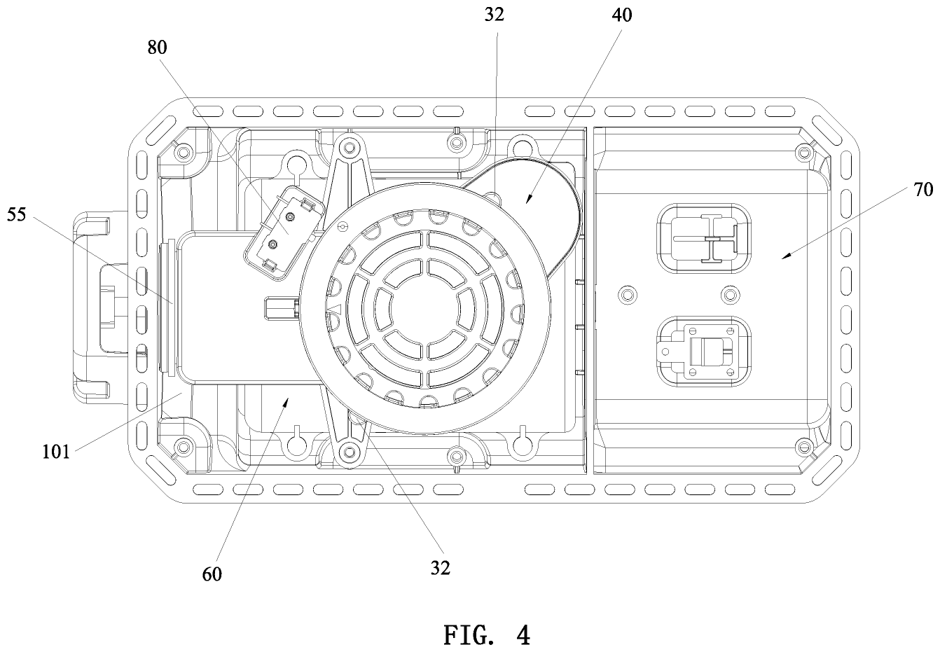

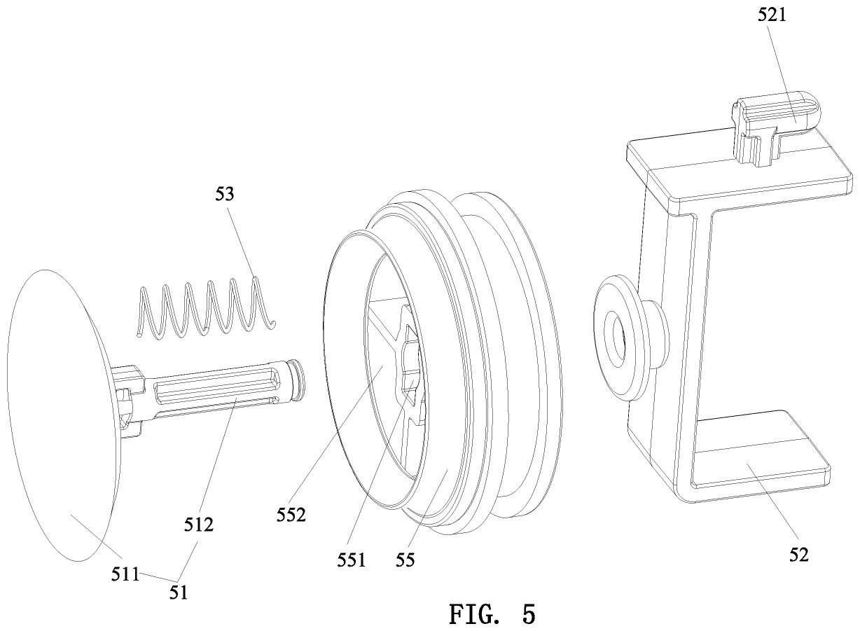

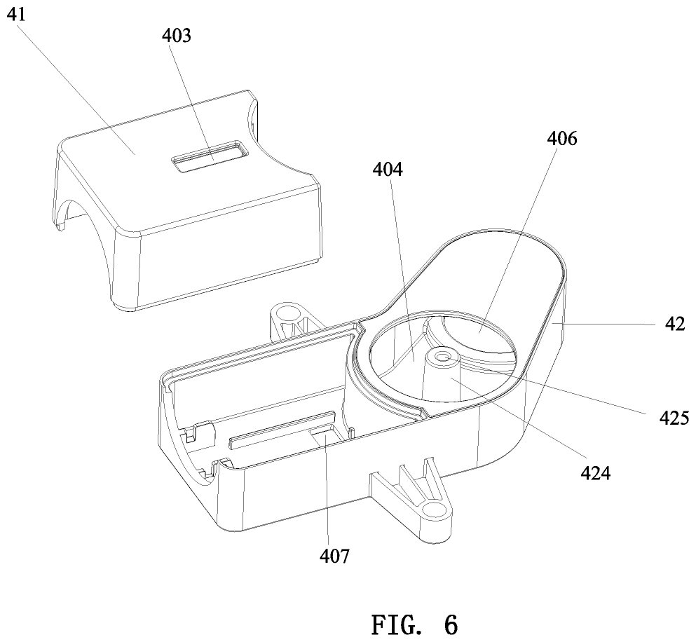

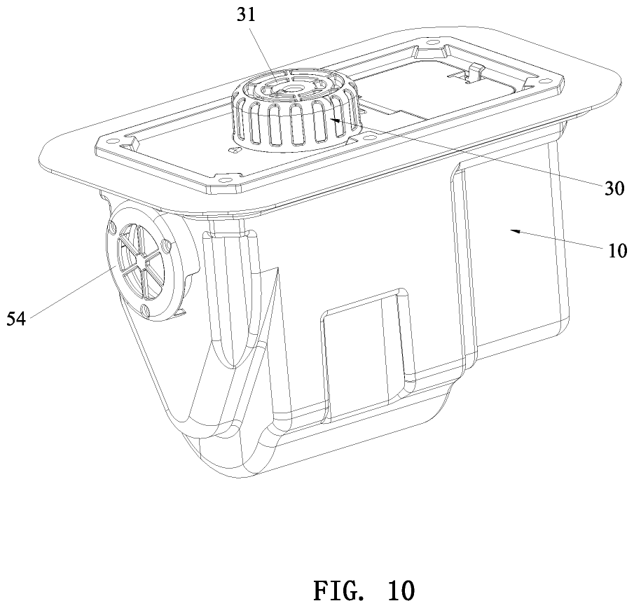

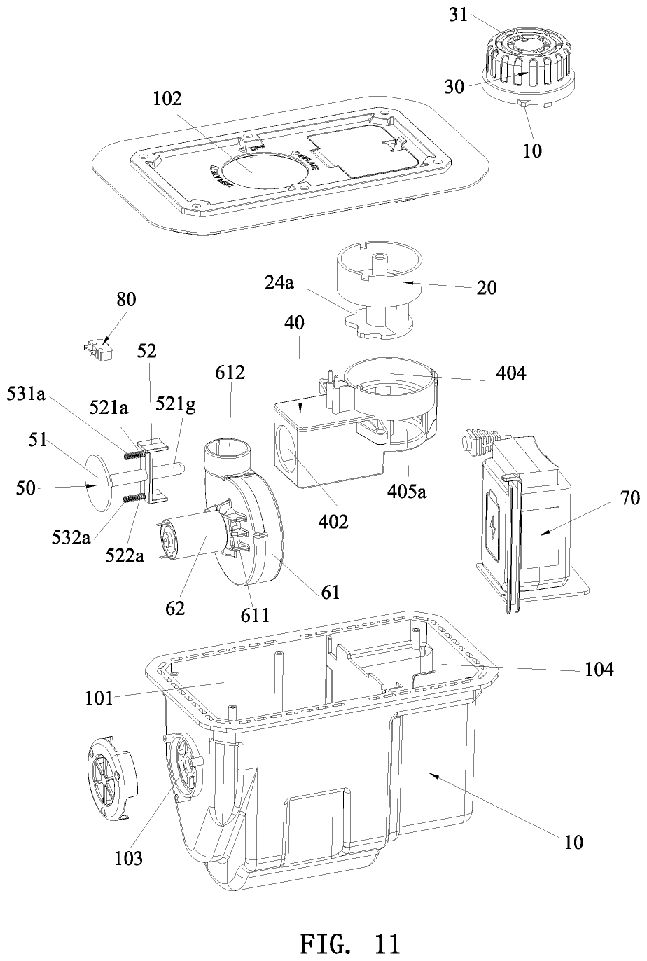

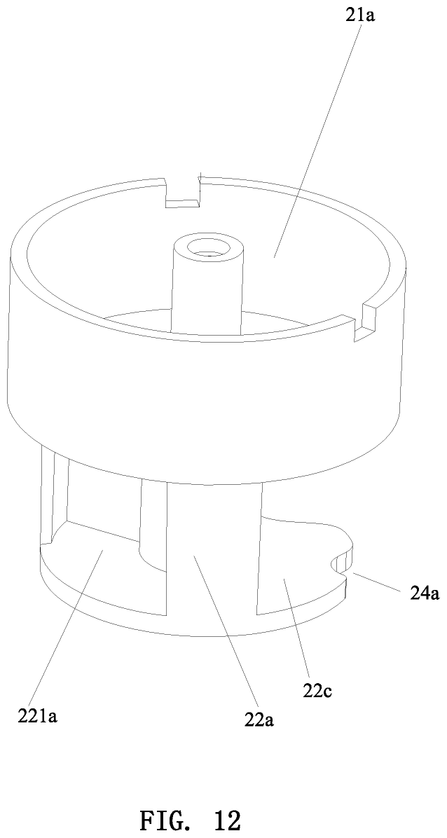

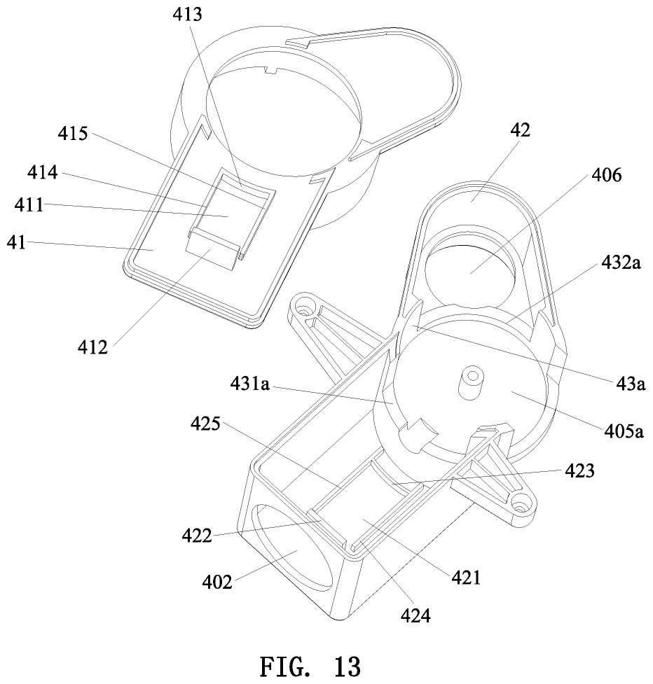

As shown in FIG. 1 through FIG. 16, an electric air pump for an inflatable product comprises an air pump base 10 having a first accommodating chamber 101 and a first vent 103. A hand wheel switch 30, an air switching cylinder 20, a diverter 40, a check valve 50, and an air pump assembly 60 are installed in the first accommodating chamber 101 of the air pump base 10. A power supply 70 and a micro switch 80 for controlling energization of a motor 62 are installed in the air pump base 10.

The hand wheel switch 30 has an inflating position, a stop position, and a deflating position. The hand wheel switch 30 is disposed in a hand wheel switch mounting hole 102 and extends out of the air pump seat 10. The hand wheel switch 30 is coupled with the air switching cylinder 20 to drive the air switching cylinder 20 to rotate. The hand wheel switch 30 is provided with a second vent 31 for communicating with outside air. The second vent 31 is selectively in communication with the diverter 40 through the air switching cylinder 20.

In this embodiment, a gap 33 is defined between the hand wheel switch 30 and the air switching cylinder 20 for communicating with the first accommodating chamber 101. The air switching cylinder 20 is formed with a cavity 21 having a lower end opening. The lower end opening is in communication with an air switching cylinder mounting hole 404.

The air pump assembly 60 includes a housing 61, a motor 62 and blades 63. The housing 61 has a pump chamber 605, an air outlet 612, and an air inlet 611 communicating with the first accommodating chamber 101. The pump chamber 605 is in communication with the air inlet 611 and the air outlet 612. An output shaft of the motor 62 is connected with the blades 63. The blades 63 are installed in the pump chamber 605. In another embodiment, both the motor 62 and the blades 63 are mounted in the pump chamber 605. The inner wall of the pump chamber 605 is formed with a partition 601 to partition the pump chamber 605 into a motor chamber 602 and a blade chamber 603. The partition 601 is formed with a blade mounting hole 604. The motor 62 is mounted in the motor chamber 602. The output shaft of the motor 62 is inserted through the blade mounting hole 604 to be connected with the blades 63. The blades 63 are mounted in the blade chamber 603.

The diverter 40 is connected to the air pump assembly 60. The diverter 40 has a diverter inner chamber 401. The diverter 40 further has a first hole 402, a second hole 403, an air switching cylinder mounting hole 404, a side opening 405, a transition hole 406 and an air switching hole 407 that communicate with the diverter inner chamber 401, respectively. An end surface of the first hole 402 of the diverter 40 is sealedly connected to the inner wall surface of a first vent 103 of the first accommodating chamber 101. The first hole 402 faces and communicates with the second vent 31. The transition hole 406 communicates with the air switching cylinder mounting hole 404. The blade chamber 603 is in communication with the diverter inner chamber 401 through the air outlet 612 and the transition hole 406. The air switching hole 407 selectively communicates with the first accommodating chamber 101. In this embodiment, the diverter 40 has a side opening 405. The cavity 21 selectively communicates with the side opening 405 as the outer circumference of the air switching cylinder 20 rotates.

The check valve 50 includes an air sealing plate 51, a first valve bracket 52, and an elastic member 53. Both the first valve bracket 52 and the elastic member 53 are disposed in the diverter inner chamber 401. The lower end of the first valve bracket 52 can close or open the air switching hole 407. The air sealing plate 51 of the check valve 50 corresponds in position to the first vent 103 for opening or closing the first vent 103. The air switching cylinder 20 is installed in the air switching cylinder mounting hole 404, such that the outer circumference of the air switching cylinder 20 when rotated can conduct or block communication between the first vent 103 and the blade chamber 603.

One end of the elastic member 53 is fixed to the inner wall of the diverter inner chamber 401, and another end of the elastic member 53 is connected to the first valve bracket 52. The air sealing plate 51 is connected to the first valve bracket 52. The first valve bracket 52 is provided with a first engaging protrusion 521. The outer circumference of the air switching cylinder 20 is formed with an annular side 22. The annular side 22 is selectively connected to the first valve bracket 52 so that the air sealing plate 51 opens or closes the first vent 103.

In this embodiment, a contact portion 23 protrudes from the annular side 22. The first engaging protrusion 521 is located in the second hole 403 and extends out of the diverter 40. The contact portion 23 is pressed against the first engaging protrusion 521 when the air switching cylinder 20 is rotated. In another embodiment, the annular side 22c is formed with at least three positioning recesses 24a. The first engaging protrusion 521g is fitted in one of the positioning recesses 24 when the air switching cylinder 20 is rotated.

The diverter 40 includes an upper housing 41 and a lower housing 42. A micro switch mounting seat 44 is formed on the upper housing 41. The upper housing 41 and the lower housing 42 are assembled together to define the diverter inner chamber 401 and the first hole 402 therein. The upper housing 41 is formed with the second hole 403 and the side opening 405. The lower housing 42 is formed with the air switching cylinder mounting hole 404, the air switching hole 407 and the transition hole 406.

In this embodiment, the lower housing 42 is formed with a post 424 integrally extending upwardly from the inner bottom wall of the air switching cylinder mounting hole 404. A shaft hole 43 is defined in the post 424. The lower end of the air switching cylinder 20 is provided with a rotating shaft 24. The rotating shaft 24 is rotatably mounted in the shaft hole 43.

In another embodiment, the inner wall of the lower housing 42 integrally extends upwardly to form a cylindrical portion 43a. The air switching cylinder mounting hole 404 is defined in the cylindrical portion 43a. The outer wall of the cylindrical portion 43 a is formed with a first opening 431a and a second opening 432a. The air switching hole of the diverter 40 is formed on the side of the lower housing 42 (in this embodiment, the air switching hole is defined as a side air switching hole 405a). The first opening 431a, the second opening 432a and the side air switching hole 405a all communicate with the air switching cylinder mounting hole 404. The second opening 432a communicates with the transition hole 406.

The air switching cylinder 20 has a hollow cavity 21a communicating with the second vent 31 and a shielding portion 22a extending downward from the outside of the hollow cavity 21a. The shielding portion 22a is formed with a third vent 221a. The third vent 221a communicates with the hollow cavity 21a. When rotated, the shielding portion 22a of the air switching cylinder selectively blocks the first opening 431a, the second opening 432a and the side air switching hole 405a to conduct or block communication between the first vent 103 and the blade chamber 603. Specifically, when the inflation is required, the shielding portion 22a faces the side air switching hole, the third vent 221a faces and communicates with the side air switching hole 405a, and the first opening 431a communicates with the second opening 432a. When it is necessary to stop the inflation, the shielding portion 22a faces the inner wall of the cylindrical portion 43a to block the third vent 221a, and the outside airflow cannot enter the first accommodating chamber through the third vent 221a. When deflation is required, the shielding portion 22a faces the second opening 432a, the third vent 221a faces and communicates with the second opening 432a, and the first opening 431a communicates with the side air switching hole 405a.

The inner wall of the upper housing 41 is formed with an upper positioning seat. The upper positioning seat has an upper positioning surface 411, a first left positioning surface 412, a first right positioning surface 413, a first front positioning surface 414 and a first rear positioning surface 415. The second hole 403 penetrates through the inner wall of the upper positioning surface 411. The front, rear and right sides of the upper end of the first valve bracket 52 are respectively limited by the first front positioning surface 414, the first rear positioning surface 415 and the first right positioning surface 413.

The inner wall of the lower housing 42 is formed with a lower positioning seat. The lower positioning seat has a lower positioning surface 421, a second left positioning surface 422, a second right positioning surface 423, a second front positioning surface 424 and a second rear positioning surface 425. The front, rear and right sides of the lower end of the first valve bracket 52 are respectively limited by the second front positioning surface 424, the second rear positioning surface 425 and the second right positioning surface 423. In this embodiment, the air switching hole 407 penetrates from the lower end of the lower housing 42 to the lower positioning surface 421. The lower end of the first valve bracket 52 can close or open the air switching hole 407 disposed at the lower end of the diverter 40.

In another embodiment, one side of the first valve bracket 52, facing the air sealing plate 51, is provided with an upper elastic member mounting post 521a and a lower elastic member mounting post 522a. Correspondingly, the elastic member includes two elastic members respectively defined as an upper elastic member 531a and a lower elastic member 532a. Two ends of the upper elastic member 531a lean against the first left positioning surface and the upper elastic member mounting post 521a, respectively. Two ends of the lower elastic member 532a lean against the second left positioning surface and the lower elastic member mounting post 522a, respectively.

The check valve 50 further includes a second valve bracket 55. The second valve bracket 55 is disposed corresponding to the first vent 103 and seals the inner wall of the first accommodating chamber 101 at the periphery of the first vent 103 and the end surface of the diverter 40 at the first hole 402. The second valve bracket 55 is formed with a third hole 551 and a plurality of fourth holes 552 arranged around the third hole 551. The fourth holes 552 communicate with the diverter inner chamber 401 and the first vent 103.

The air sealing plate 51 has an air sealing plate body portion 511 and a shaft portion 512 integrally extending rearward from the rear end of the air sealing plate body portion 511. After the shaft portion 512 is inserted in the third hole 551 and fitted onto the elastic member 53 to be connected to the first valve bracket 52, the air sealing plate body portion 511 can close or open the fourth hole 552.

The outer circumference of the hand wheel switch 30 is provided with at least two second engaging protrusions 32. The two second engaging protrusions 32 are at a height same as the micro switch 80. The second engaging protrusions 42 are equidistant from the center of the air switching cylinder 20 and located oppositely. The second engaging protrusions 32 are configured to touch the micro switch 80 for energizing the motor 62 when the air switching cylinder 20 is rotated.

In this embodiment, the diverter 40 is provided with a micro switch mounting seat 44. The micro switch 80 is mounted on the micro switch mounting seat 44. Preferably, a mounting post 441 is formed on the micro switch mounting seat 44. The micro switch 80 has a mounting slot 81. The mounting post 441 is fitted into the mounting slot 81.

A first limiting block 442 and a second limiting block 443 are oppositely disposed on the micro switch mounting seat 44. The first limiting block 442 and the second limiting block 443 are spaced apart to form a clamping space for the micro switch 80. The upper end faces of two sides of the micro switch 80 are limited by the lower end faces of both the first limiting block 442 and the second limiting block 443.

Preferably, the first limiting block 442 and the second limiting block 443 each have an inlet guiding slope 444 and an outlet guiding slope 445. The inlet guiding slope 444 is disposed obliquely, inwardly in the inlet direction. The outlet guiding slope 445 is vertically disposed and extends from the lower end of the inlet guiding slope 444.

The air pump seat base 10 has a second accommodating chamber 104 that is open at one end thereof. The power supply 70 is installed in the second accommodating chamber 104 from the open end. A lid 11 also covers the second accommodating chamber 104.

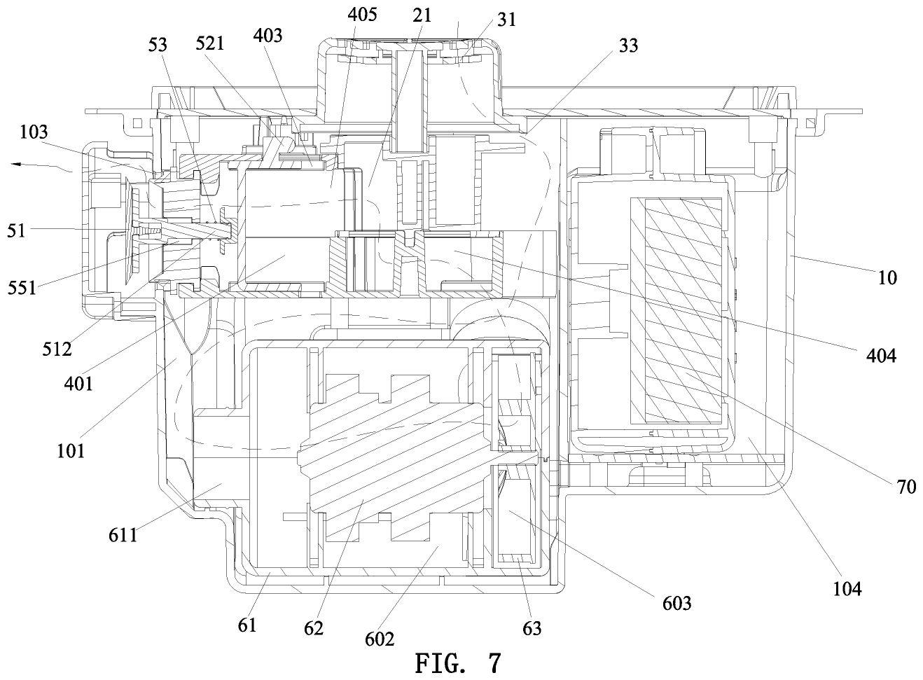

Next, the working principle of this embodiment is described hereinafter, as shown in FIG. 7 to FIG. 9.

When the inflation is required, the hand wheel switch 30 is rotated to the inflation position. At this time, the hand wheel switch 30 drives the air switching cylinder 20 to rotate, the first engaging protrusion 521 is in contact with the annular side 22, the cavity 21 communicates with the side opening 405, and the lower end opening communicates with the air switching cylinder mounting hole 404. At the same time, the motor 62 is energized to drive the blades 63 to rotate. The outside airflow sequentially passes through the second vent 31, the gap 33, the first accommodating chamber 101, the air inlet 611, the motor chamber 602, the blade chamber 603, the air outlet 612, the transition hole 406, the air switching cylinder mounting hole 404, the lower end opening, the cavity 21 and the opening 405 to enter the diverter inner chamber 401. The air sealing plate 51 of the check valve 50 is in a state of opening the first vent 103 under the action of the air pressure, and the airflow in the diverter inner chamber 401 enters the product to be inflated via the first vent 103.

When it is necessary to stop the inflation, the hand wheel switch 30 is rotated to the stop position. At this time, the hand wheel switch 30 drives the air switching cylinder 20 to rotate, the side opening 405 does not communicate with the cavity 21, the cavity 21 communicates with the first accommodating chamber 101, and the lower end opening communicates with the air switching cylinder mounting hole 404. At the same time, the motor 62 stops energizing. The outside airflow cannot pass through the second vent 31, the gap 33, the first accommodating chamber 101, the air inlet 611, the motor chamber 602, the blade chamber 603, the air outlet 612, the transition hole 406, the air switching cylinder mounting hole 404, the lower end opening, the cavity 21 and the side opening 405 to enter the diverter inner chamber 401. When the airflow of the diverter inner chamber 401 of the diverter is kept constant, the elastic member 53 is returned, the air sealing plate 51 of the check valve 50 is in a state of closing the first vent 103, and the first engaging protrusion 521 is in contact with the annular side 22.

When the deflation is required, the hand wheel switch 30 is rotated to the deflation position. At this time, the hand wheel switch 30 drives the air switching cylinder 20 to rotate. The contact portion abuts against the first engaging protrusion 521. The air sealing plate 51 of the check valve 50 is in a state of opening the first vent 103. The air switching hole 407 is in communication with the first accommodating chamber 101, the side opening 405 is not in communication with the cavity 21, the cavity 21 is in communication with the first accommodating chamber 101, and the lower end opening is in communication with the air switching cylinder mounting hole 404. At the same time, the motor 62 is energized to drive the blades 63 to rotate. The airflow in the product to be inflated sequentially passes through the first vent 103, the diverter inner chamber 401, the air switching hole 407, the first accommodating chamber 101, the air inlet 611, and the motor chamber 602, the blade chamber 603, the air outlet 612, the transition hole 406, the air switching cylinder mounting hole 404, the lower end opening, the cavity 21, the gap 33 and the second vent 31 to the outside.

Next, the working principle of another embodiment is described hereinafter.

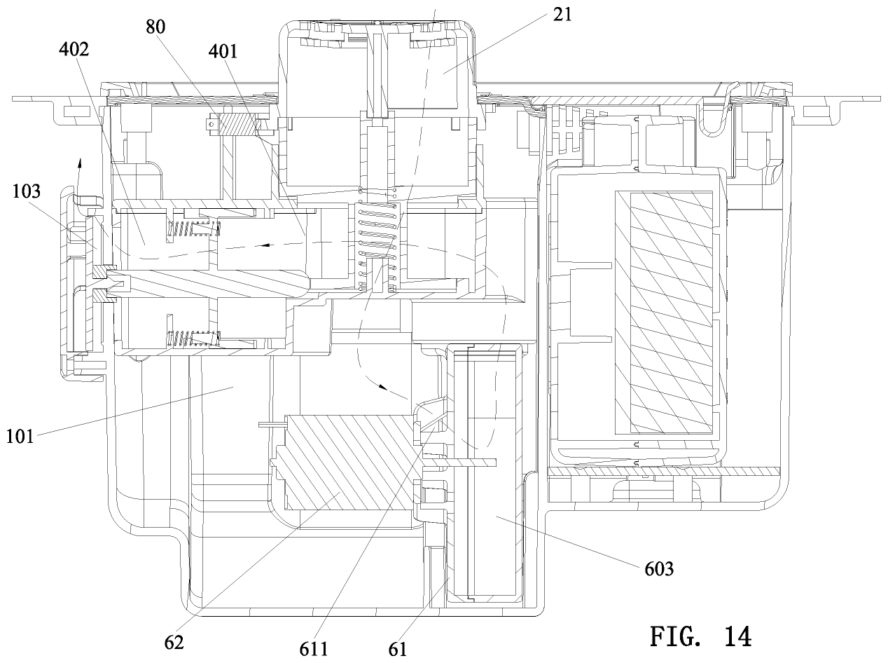

When the inflation is required, as shown in FIG. 14, the difference from FIG. 7 is that the first engaging protrusion 521g is fitted in the first the positioning recess 24a, and the third vent 221a is in communication with the first accommodating chamber 101 through the side air switching hole 405a. The outside airflow sequentially passes through the second vent 31, the hollow cavity 21a, the third vent 221a, the side air switching hole 405a, the first accommodating chamber 101, the air inlet 611, the blade chamber 603, the air outlet 612 and the transition hole 406 to enter the diverter inner chamber 401.

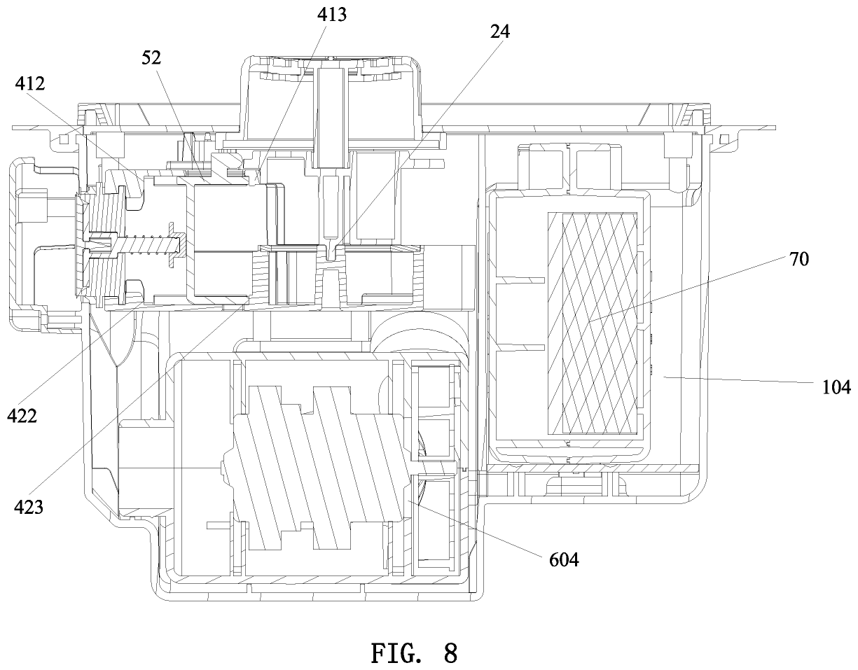

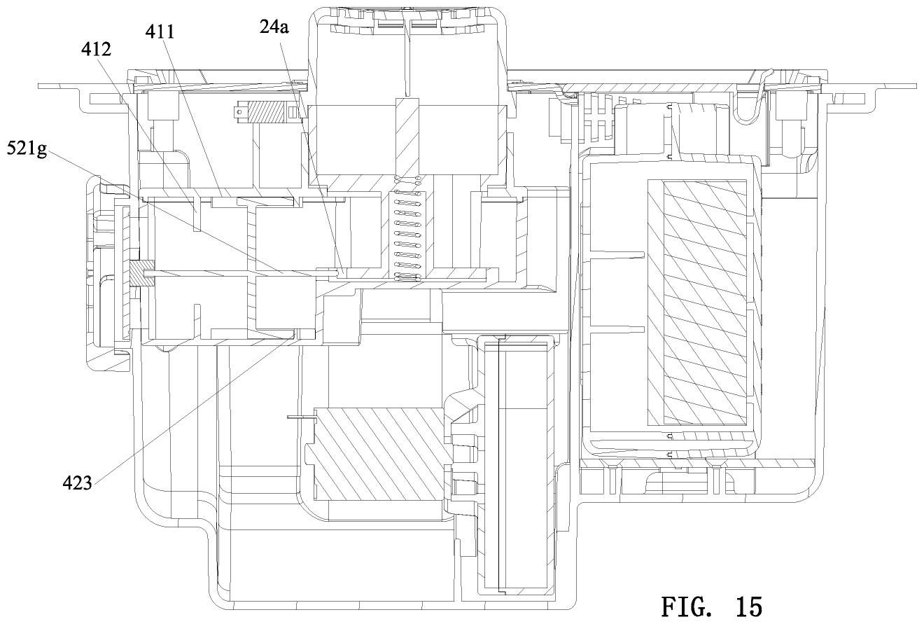

When it is necessary to stop the inflation, as shown in FIG. 15, the difference from FIG. 8 is that the third vent 221a is not in communication with the first accommodating chamber 101, the outside airflow cannot pass through the second vent 31, the hollow cavity 21 and the third vent 221a to enter the first accommodating chamber 101, and the first engaging protrusion 521g is fitted in the second positioning recess 24a.

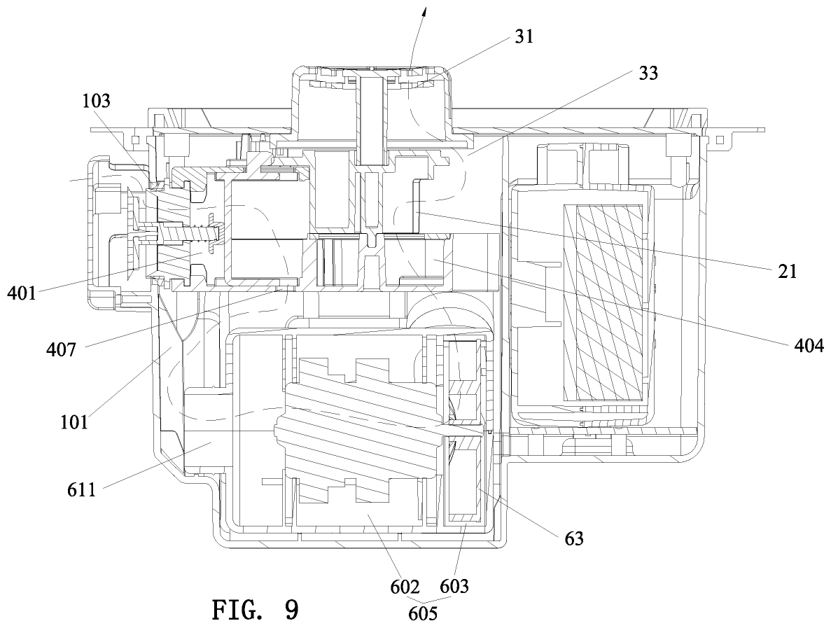

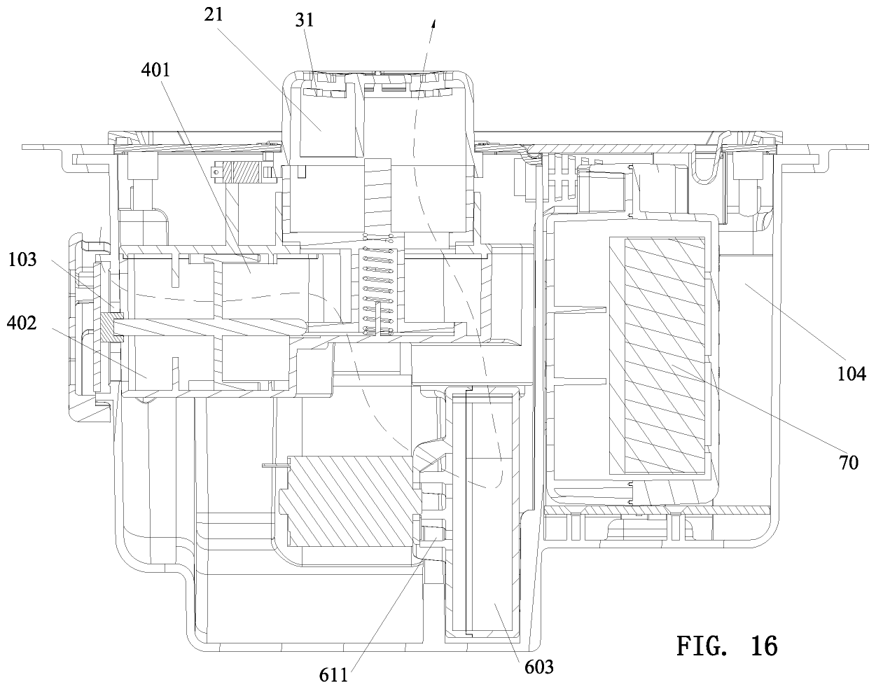

When the deflation is required, as shown in FIG. 16, the difference from FIG. 9 is that the first engaging protrusion 521g is fitted in the third positioning recess 24a, and the third vent 221a is in communication with the blade chamber 603 through the transition hole 406 and the air outlet 612. The airflow in the product to be inflated passes through the first vent 103, the diverter inner chamber 401, the side air switching hole 405, the air inlet 611, the blade chamber 603, the air outlet 612, the transition hole 406, the third vent 221a, the hollow cavity 21a and the second vent 31 to enter the outside.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. An electric air pump for an inflatable product, comprising an air pump base having a first accommodating chamber and a first vent, a hand wheel switch, an air switching cylinder, a diverter, a check valve and an air pump assembly being installed in the first accommodating chamber of the air pump base;
the hand wheel switch being disposed in a hand wheel switch mounting hole and extending out of the air pump seat, the hand wheel switch being coupled with the air switching cylinder, the hand wheel switch being provided with a second vent for communicating with outside air; the second vent being selectively in communication with the diverter through the air switching cylinder;
the air pump assembly including a housing, a motor and blades, the housing having a pump chamber, an air outlet and an air inlet communicating with the first accommodating chamber, an output shaft of the motor being connected with the blades, the blades being installed in the pump chamber; the pump chamber communicating with the air inlet and the air outlet;
the diverter being connected to the air pump assembly, the diverter having a diverter inner chamber, the diverter further having a first hole, an air switching cylinder mounting hole, a transition hole and an air switching hole that are in communication with the diverter inner chamber respectively, an end surface of the first hole of the diverter being sealedly connected to an inner wall surface of the first vent of the first accommodating chamber, the first hole communicating with the first vent, the transition hole communicating with the air switching cylinder mounting hole, the pump chamber being in communication with the diverter inner chamber through the air outlet and the transition hole, the air switching hole selectively communicating with the first accommodating chamber;
the check valve being configured to open or close the first vent, the air switching cylinder being installed in the air switching cylinder mounting hole so that an outer circumference of the air switching cylinder when rotated can conduct or block communication between the first vent and the pump chamber;
the check valve including an air sealing plate, a first valve bracket and an elastic member, the air sealing plate being connected to the first valve bracket, the outer circumference of the air switching cylinder being formed with an annular side, the annular side being selectively connected to the first valve bracket so that the air sealing plate opens or closes the first vent;
one end of the elastic member being fixed to an inner wall of the diverter inner chamber, another end of the elastic member being connected to the first valve bracket.

2. The electric air pump as claimed in claim 1, wherein a gap is defined between the hand wheel switch and the air switching cylinder for communicating with the first accommodating chamber, the air switching cylinder is formed with a cavity having a lower end opening, the lower end opening is in communication with an air switching cylinder mounting hole, the diverter further has a side opening, and the cavity selectively communicates with the side opening as the outer circumference of the air switching cylinder rotates.

3. The electric air pump as claimed in claim 1, wherein the first valve bracket is provided with a first engaging protrusion; the annular side is formed with at least three positioning recesses, the first engaging protrusion is fitted in one of the positioning recesses when the air switching cylinder is rotated;

4. The electric air pump as claimed in claim 1, wherein the first valve bracket is provided with a first engaging protrusion; the diverter has a second hole communicating with the diverter inner chamber, the first engaging protrusion is located in the second hole and extends out of the diverter, and a contact portion protrudes from the annular side for touching the first engaging protrusion.

5. The electric air pump as claimed in claim 2, wherein the diverter includes an upper housing and a lower housing, the upper housing and the lower housing are assembled together to define the diverter inner chamber and the first hole therein, the upper housing is formed with the side opening, and the lower housing is formed with the air switching cylinder mounting hole, the air switching hole and the transition hole.

6. The electric air pump as claimed in claim 5, wherein the lower housing is formed with a post integrally extending upwardly from an inner bottom wall of the air switching cylinder mounting hole, a shaft hole is defined in the post, a lower end of the air switching cylinder is provided with a rotating shaft, the rotating shaft is rotatably mounted in the shaft hole.

7. The electric air pump as claimed in claim 5, wherein an inner wall of the lower housing integrally extends upwardly to form a cylindrical portion, the air switching cylinder mounting hole is defined in the cylindrical portion, an outer wall of the cylindrical portion is formed with a first opening and a second opening, the air switching hole of the diverter is formed on a side of the lower housing, the first opening, the second opening and the air switching hole communicate with the air switching cylinder mounting hole, the second opening communicates with the transition hole; the air switching cylinder has a hollow cavity communicating with the second vent and a shielding portion extending downward from an outside of the hollow cavity, the shielding portion is formed with a third vent, the third vent communicates with the hollow cavity; when rotated, the shielding portion of the air switching cylinder selectively blocks the first opening, the second opening and the air switching hole to conduct or block communication between the first vent and the blade chamber.

8. The electric air pump as claimed in claim 5, wherein an inner wall of the upper housing is formed with an upper positioning seat, the upper positioning seat has an upper positioning surface, a first left positioning surface, a first right positioning surface, a first front positioning surface and a first rear positioning surface, front, rear and right sides of an upper end of the first valve bracket are limited by the first front positioning surface, the first rear positioning surface and the first right positioning surface, respectively;
an inner wall of the lower housing is formed with a lower positioning seat, the lower positioning seat has a lower positioning surface, a second left positioning surface, a second right positioning surface, a second front positioning surface and a second rear positioning surface, front, rear and right sides of a lower end of the first valve bracket are limited by the second front positioning surface, the second rear positioning surface and the second right positioning surface, respectively.

9. The electric air pump as claimed in claim 8, wherein the air switching hole of the diverter penetrates from a lower end of the lower housing to the lower positioning surface, and the lower end of the first valve bracket can close or open the air switching hole disposed at a lower end of the diverter.

10. The electric air pump as claimed in claim 8, wherein one side of the first valve bracket, facing the air sealing plate, is provided with an upper elastic member mounting post and a lower elastic member mounting post, the elastic member includes two elastic members respectively defined as an upper elastic member and a lower elastic member, two ends of the upper elastic member lean against the first left positioning surface and the upper elastic member mounting post respectively, and two ends of the lower elastic member lean against the second left positioning surface and the lower elastic member mounting post respectively.

11. The electric air pump as claimed in claim 1, further comprising a power supply for supplying power and a micro switch for controlling energization of the motor, the power supply and the micro switch being installed in the air pump base, an outer circumference of the hand wheel switch being provided with at least two second engaging protrusions, the two second engaging protrusions being at a height same as the micro switch, the second engaging protrusions being equidistant from a center of the air switching cylinder and located oppositely, and the second engaging protrusions are configured to touch the micro switch for energizing the motor when the air switching cylinder is rotated.

12. The electric air pump as claimed in claim 11, wherein the diverter is provided with a micro switch mounting seat, the micro switch is mounted on the micro switch mounting seat; a mounting post is formed on the micro switch mounting seat, the micro switch has a mounting slot, the mounting post is fitted into the mounting slot.

13. The electric air pump as claimed in claim 11, wherein the diverter is provided with a micro switch mounting seat, the micro switch is mounted on the micro switch mounting seat; a first limiting block and a second limiting block are oppositely disposed on the micro switch mounting seat, the first limiting block and the second limiting block are spaced apart to form a clamping space for the micro switch, upper end faces of two sides of the micro switch are limited by lower end faces of the first limiting block and the second limiting block.
